(19) United States
(12) Patent Application Publication
(10) Pub. No.: US 2001/0008660 A1
(43) Pub. Date: Jul. 19, 2001

(54) MULTILAYER BARRIER SHRINK FILM

(76) Inventors: ALAN D. STALL, NAPERVILLE, IL (US); STEVEN A. MOGENSEN, LAKEVILLE, MN (US)

Correspondence Address: KINNEY & LANGE,P.A., THE KINNEY & LANGE BUILDING, 312 SOUTH THIRD STREET, MINNEAPOLIS, MN, 554151002

(21) Appl. No.: 09/130,561

(22) Filed: Aug. 7, 1998

(51) Int. Cl. B32B 1/02

(52) U.S. Cl. 428/35.4

(57) ABSTRACT

A multilayered packaging film includes a first exterior layer of a heat sealable polymer and second exterior layer on a side opposite from the first exterior layer, and including two inner layers made of polyvinylidene chloride disposed between the first and second layers and an innermost core layer disposed between the two inner layers wherein the innermost core layer is not crossed-linkable when exposed to radiant energy.

### BACKGROUND OF THE INVENTION

This invention generally relates to multilayer barrier shrink films and to bags made therefrom. More particularly, a multilayer barrier film or bag is provided having at least two core layers of a PVDC gas barrier material and at least one core layer of a propylene-ethylene random copolymer. The present invention is especially well-suited for vacuum packaging situations where toughness, resistance to puncture, and high shrink values are important, such as in packaging meat cuts, including those containing protruding bone portions.

Polymeric films are well known for packaging applications, approximately half of which are currently food packaging applications which address the perishability of foods. Foods are especially vulnerable to degradation upon exposure to oxygen. Refrigeration, thermal processing after packaging, reduction of water content and the like are practiced to varying degrees and in varying combinations in order to reduce degradation of foods and food products. A very effective approach in this regard is to cover or envelope the food item with a polymeric film containing a so-called barrier layer. Barrier layers are known to prevent oxygen from reaching the product.

Another concern, especially when working with food packaging applications, is attempting to eliminate residual oxygen contained inside the food package. One popular method which has been practiced with a view toward eliminating residual oxygen is to package the film-enveloped food inside a vacuum chamber where a substantial quantity of oxygen has been evacuated. The film therefore clings tightly to the outside surface of the product when the thus packaged product is re-exposed to air after packaging. Subsequent spraying or immersion of the package in hot water causes the film to shrink tightly around the product, providing it with an especially wholesome aesthetic appearance, while keeping food juices and the like tightly retained inside the package and avoiding or minimizing the collection of liquid in gaps and crevices in the packaging and between the packaging and the product.

It is well known to co-extrude films to produce a multilayer product useful in these types of applications. Included are film products which have been biaxially oriented to thermally expand the film, allowing for future retraction by heat. Films of this type have been processed into a bag and used on evacuation equipment for vacuum packaging of various products, including food products and bone-in meat products or other items having grossly irregular surfaces. Multilayer heat shrinkable films in this regard include those described in U.S. Pat. No. 2,762,720, where a multilayer film of 80% polyvinylidene chloride (PVDC) is combined with 20% of another polymeric material such as polyethylene terephthalate (PET) for providing added mechanical strength and enhanced appearance.

Also included in the background art are U.S. Pat. No. 3,022,543 and No. 3,567,539, which illustrate a system for extruding laminate successive layers. This approach includes irradative cross-linking of the innermost layer, a polyolefin, and subsequent reheating and laminating to it a PVDC intermediate layer and then an outer polyolefin layer, preferably ethylene vinyl acetate (EVA) having a vinyl acetate content of 3% to 28%. The entire composite thus constructed is then reheated in a hot water bath, biaxially oriented, and wound on a reel as a flattened tube. The tube is stretched 100% in the machine and in the transverse directions. Tubes of this type can be made into bags on conventional bag-making machinery.

Biaxial orientation enhancement has been known to be practiced by a so-called double bubble approach. In approaches such as those of U.S. Pat. No. 3,278,663, No. 3,456,044 and No. 3,555,604, all of which are incorporated herein by reference, a first bubble is blown to carry out an initial biaxial orientation. A secondary bubble is also created, with infrared heaters being used. Bubble quenching is practiced using suitable quenching approaches such as cold air ring sprays. U.S. Pat. No. 4,188,350 and No. 4,196,240 propose a biaxially oriented film using polyethylene-polypropylene blends with an Ionomer such as Surlyn 1650 as a core layer, no barrier being proposed. Various other films are proposed as being suitable for biaxial orientation and provide heat shrinkability useful in certain applications.

As further background, films are known to have been irradiated, including before biaxial orientation. Included in this regard are U.S. Pat. No. 4,044,187 and No. 4,104,404. Biaxially orientable films are proposed having multiple layers such as a four-layer structure as in U.S. Pat. No. 4,207,363 and up to five-layer structures as in U.S. Pat. No. 4,457,960.

### BRIEF SUMMARY OF THE INVENTION

In accordance with the present invention, important advances in multilayered barrier shrink films and bags are provided. the multilayered film has at least five functional layers. The inside, product-contacting layer is referred to herein as the heat seal layer. The outside layer, which is visible to the potential purchaser or the bagged product, is referred to herein as the abuse layer. The intermediate layers or core layers positioned between the heat seal layer and the abuse layer are referred to herein as the shrink layers, the barrier layers, or the shrink/barrier layers. An adhesive layer typically will be positioned between all or some of the functional layers. The multilayered film is biaxially oriented and irradiated.

In an important aspect of this invention, the innermost core layer does not cross-link during this irradiation procedure, while the other functional layers do respond to the irradiation. Thus, the multilayered barrier shrink film is non-irradiated in the sense that it is not significantly affected by the irradiation applied to the totality of the film, while the remainder of the functional film layers are fully irradiated. In this regard, the innermost core layer is preferably a propylene ethylene copolymer (PER), either alone or in combination with another component or other components. It is also an important aspect of this invention that at least two barrier core layers include polyvinylidene chloride (PVDC). It is also preferred that the seal layer and abuse layer include an ultra density polyethylene (ULDPE), or in situations where abuse is not as great a concern, ethylene vinyl acetate (EVA) can be substituted for or combined with the ULDPE, in combination with additional components if so desired in certain instances.

### DETAILED DESCRIPTION

Multilayered coextrusions in accordance with the present invention incorporate a minimum of five functional layers, suitably adhered together, typically by an interspersed adhesive layer or by an adhesive included within one or more of the working layers. Considering the product-contacting layer of the coextrusion to be an inside, heat seal layer, the outside or external layer is an abuse layer, while the coextrusion contains three or more shrink/barrier layers therebetween.

The present invention includes a new approach in coextruded multilayered film polymers having superior vacuum conformance properties and which offer excellent protection, both from physical abuse and from transference of gases such as oxygen therethrough. There is a need for packaging film and bags which exhibit barrier protection and mechanical strength and abuse protection, while possessing the ability to shrink so as to tightly envelope, closely follow, and not be damaged by a wide range of contours, including those which are relatively sharp, upon shrinking, such as those presented by bone-in meat cuts and the like.

With more particular reference to the innermost core layer, this includes as a primary component or as the only component thereof a polymer which will not significantly crosslink when the multilayer barrier shrink film is subjected to irradiation. Included in this regard are polymers including polypropylene, which also exhibits the property or reasonably good adherence to the shrink/barrier layer. It also exhibits the additional advantage of providing a good barrier to fat and/or grease transmission.

A preferred innermost core layer according to the present invention is a propylene-ethylene copolymer (PER). Such a PER should be a random copolymer in order to allow the polypropylene component to properly adhere to the shrink layer. In this regard, the randomness index is preferably approximately 0.5, while the melt flow is typically approximately 1.7 grams per 10 minutes. The innermost core layer should have a high isotactic molecular structure and should have a melt flow of about 1.5 to about 10 decigrams per minute. A PER component of the innermost core layer should have a relatively low ethylene content, typically not greater than about 6% ethylene on a weight basis preferably not greater than about 5% ethylene on a weight basis. These types of PER materials will not crosslink upon irradiation. Typical manufacturers of PER materials are Exxon Corporation of Irving, Tex.; Millenium Chemicals, Inc. of Iselin, N.J.; Phillips Chemical Co. of Houston, Tex. and Montell of Hoofdorp, Netherlands.

With further reference to the inner most core layer, same can be composed entirely of a PER material. It can also be blended with other components when particular properties are desired. Such other components include specialty polyethylenes such as linear low density polyethylene (LLDPE) and ultra density polyethylene (ULDPE). Elastomeric properties can be enhanced by blending into the innermost core layer materials such as polybutylene or ethylene-butene copolymer. Examples of elastomers which can be included within the innermost core layer are ethylene-propylene copolymers or other types such as Vistalon® 702 from Exxon Corporation, or Telcar® 303 from B F Goodrich Company of Richfield, Ohio. Such elastomers can be included at a level of about 10% of the inside heat seal layer, thereby promoting adhesion. Adherence to the intermediate shrink/barrier layers can be provided by or enhanced by the inclusion of a suitable adhesive as generally discussed herein as a component blended with the innermost core layer. Typically, blends of such components in this or other layers are physical mixtures which are preblended and flow into a single extruder feed location.

When it is desired to reduce crystallinity of the PER in the innermost core layer, ethylene acid copolymer (EAA) can be blended thereinto. Typically, such an addition will allow easier bubble blowing, improve optics and improve adhesion. Other materials for blending with PER in the innermost core layer include ethylene-methyl acrylate blends, such having elastomeric properties, good adhesion, thermal stability and compatibility with materials such as EVA, PVDC and EAA. PER can also be blended with butene-ethylene copolymers.

Referring now to the barrier core layers, these include the material PVDC in particular for its barrier to moisture and more particularly for its barrier to gases. Importantly, a synergistic improvement in moisture barrier of the entire structure is obtained by dividing a similar amount of PVDC material into two layers as opposed to the use of a similar amount of material in just one layer. More importantly, a synergistic improvement in gas barrier of the entire structure is obtained by dividing a similar amount of PVDC material into two layers as opposed to the use of a similar amount of material in just one layer. A suitable PVDC is MA Saran, available from Dow Chemical Company of Midland, Mich., other suppliers being Kureha Chemical Industry Co., Ltd. of Japan and Solvay of Brussels, Belgium, as well as Dow MA 123 Saran, MA 119 Saran and MA 127 Saran made by Dow Chemical Company. Such materials exhibit toughness and durability.

Referring now to the seal layer and abuse layer, these include a material which provides stabilized stretching, improved heat stability, resistance to oils, improved seal strength in the presence of oils, and helps to improve biaxial orientation and to broaden the application temperature range. Preferred in this regard are ultra low density polyethylene (ULDPE) materials. ULDPE materials tend to be somewhat expensive, but do not adhere well to certain materials such as polyvinylidene chloride (PVDC) or hydrolyzed ethylene vinyl acetate (EVOH). Typical ULDPE materials are Affinity PL-1840 and PL-1845 made by Dow Chemical Company of Midland, Mich. The former has a melt flow of 1.0 decigrams per minute, with 9.5% octene comonomer. Generally speaking, ULDPE polymers are polyolefins that provide high impact and puncture resistance. Because of the poor adherence of ULDPE materials to many of the materials of the multilayer film, adhesive layers or additives may be needed in order to achieve the necessary adherence between the ULDPE-containing layer and the adjacent layer. ULDPE materials provide a further advantage of exhibiting excellent hot-tack, with the result that the seal is strong even before it is cooled, which is particularly advantageous for shrink bags, where seals need to be made on a film enclosure or bag which is changing in dimension.

When it is desired to reduce costs, the seal layer and abuse layer can include EVA to replace some of the ULDPE materials. ULDPE material offers good printability for outside indicia, and it contributes good clarity to this layer. Another component which can be included in the seal layer and abuse layer is a specialty polyethylene such as an ionomer. Ionomers have the important advantage of enhancing blowability.

A typical EVA when present in the abuse layer or in the shrink layer has a low melt flow, such as 0.3 dg/min, which is typical of Dupont® 3135 made by E. I. DuPont De Nemours and Company of Wilmington, Del. When included within the heat seal layer, EVA should be of a higher melt flow in order to better promote adhesion, such a heat flow being on the order of 0.7 dg/min, typical of Dupont® 3165 and Union Carbide® 6833 made by Union Carbide of Danbury, Conn. With respect to the vinyl acetate content of the EVA component, when included, Dupont® 3135 has a VA content of 12%. The higher VA content EVA's have an increased low temperature heat stability, resilience, flexure resistance, impact resistance, toughness, coefficient of friction, clarity and abrasion resistance. It is important that the VA content not be too high so as to cause burn through on seals during packaging with the heat sealing equipment. Alternatives are LLDPE polymers, which offer similar heat sealability and flexibilities as do 4% to 18% EVA copolymers. A typical LLDPE is an ultra low density polyethylene having densities below 0.915 g/cc.

PVDC normally has poor adhesion to ULDPE materials, and mixing ULDPE with EVA improves this adhesion. Further improvement in this regard is available by adding an adhesion additive such as Dupont® CXA 3101 or CXA 1104 to the mixture, for example. Alternatives include Plexar 5298 from Millenium Chemicals, Inc. In those situations where polypropylene contacts PVDC or EVA, adhesion enhancers also can be used, such as DuPont® CXA 3101 or CXA 1202. Adding CXA adhesive resin provides a high melt index and a low melt viscosity component. Particularly suitable is blending with DuPont® 3135 EVA, which has a 0.35 melt index and a 12% VA content.

With further reference to the adhesive layers, an adhesive layer will preferably be present between each of the heat seal layer and the shrink/barrier layer, as well as between the shrink/barrier layer and the abuse layer. A discrete adhesive layer can be omitted in the event that adequate adhesive component is present in one of the layers, such as the heat seal layer to allow for adequate adhesion to the adjacent layer, for example the shrink/barrier layer. Adhesive can also be omitted in those situations where the adjoining layers adhere well to each other, such as when the shrink/barrier layer is PVDC and the abuse layer is EVA or a large percentage of EVA. A typical suitable adhesive is low density polyethylene adhesive. An example is Admer® LF 500 from Mitsui Petrochemical Industries, Ltd. of Tokyo, Japan.

In the coextruded film, it is usually important that the inside heat seal layer be the thickest layer, typically accounting for about 40-60% of the coextrusion, usually 50-60%. The barrier or core layer typically makes up about 10-20% of the coextrusion, while the outside, abuse layer makes up about 15-355 of the coextrusion. A typical adhesive layer accounts for about 3-5% of the coextrusion. The final film will have a total thickness of between about 50-90 microns (about 2-3.8 mils).

Once the various layers are coextruded, they are quenched biaxially oriented, and then annealed slightly using infrared heat. Preferably, the film is rechilled after annealing, followed by irradiation. Preferably, the irradiation takes place while the film is on a reel, the dosage being between about 2 and 10 megarads. Exemplary equipment in this regard is Electron Beam Curing equipment available from RPC of Hayward, Calif., or ESI of Woburn, Mass.

Annealing procedures as discussed herein are useful in controlling the flatwidth of the coextrusion more precisely. Flatwidth control is useful when the coextrusion includes Ionomer component(s). With this approach, approximately 5% of the flatwidth is annealed out of the coextruded film. This allows more accurate gauge control. Such annealing can be practiced using infrared heat. It is especially preferred that the annealing be carried out with a small quantity of nitrogen trapped between squeeze rolls in order to thereby inflate the film and prevent any film-to-film adhesion.

Exemplary illustrations of the disclosure herein are provided in the following examples.

### EXAMPLE 1

A blend of approximately 60% PER and 40% polybutylene are introduced into the innermost core extruder (about 2½ inches diameter, 24:1 L/D ratio) of a known double bubble extrusion line, with water quench. This is for forming the innermost core layer. The next layer for the coextrusion equipment is pure elastomeric adhesive, using a ¾ inch extruder. The outer shrink/barrier layer or core layer is made of Dow® MA Saran plasticized PVDC, such core layer being 1 inch, 20:1 L/D. The outer layer of coextrusion extrudes ULDPE plus EVA blend through a 1½ inch, 24:1 L/D extruder. Towards the inside, the next layer for the coextrusion equipment is pure elastomeric adhesive, using a ¾ inch extruder. The inner shrink/barrier layer or core layer is made of Dow® MA Saran plasticized PVDC, such core layer being 1 inch, 20:1 L/D. The inner layer of coextrusion extrudes ULDPE plus EVA blend through a 2½ inch, 24:1 L/D extruder. With this set up, extrusion thicknesses are as follows. The inside heat seal layer composes approximately 40% of the structural thickness, each adhesive layer composes about 4% of the structural thickness of the coextruded film, each barrier core layer composes 6% of the coextruded film, the innermost core layer composes 20%, and the outer, abuse layer makes up about 20% of the coextrusion. Each thickness can vary plus or minus 25%, depending upon specific resins and intended applications for the coextruded multilayer barrier shrink film. The extruder runs a 3 inch primary flatwidth, approximately 50 mils thick, at approximately 30 feet per minute. An internal powder is sprayed on the inside during extrusion, and quenching is carried out using a series of spray rings emitting chilled water.

The resulting coextrudate is quenched, but kept warm (approximately 100° F.) to ensure the primary web is not crystallized, but is amorphous for reblowing. The web is conveyed upwardly into a known biaxial orientation unit, where infrared heat is applied using a series of rotating heater bands. The primary web is heated above the glass transition temperatures of all of the resins, and a secondary biaxial orientation is effected. the secondary web is blown to about 14 inches, and the line speed of the exiting nip roll is about 130 feet per minute. The primary web thins out to about 2.5 mil thickness. The film is completely quenched exiting the secondary heater stack using dry air, chilled to 40° F. the product is then reheated using infrared, and annealed, with a trapped bubble of nitrogen or dry air in between two squeeze rolls, to a 13 inch width. The resulting final product is recooled and wound on a surface wound reeler.

The resulting film is allowed to sit in cold storage for two days to thermally stabilize and crystallize. The film is then taken to a commercial electron beam curing unit, where it is irradiated to crosslink all but the PER layer, with a dosage of about 4 megarads. The thus prepared product is then wound, with inflation prior to winding to ensure gases evolved during crosslinking are not entrained in the film.

After treatment and a sitting time of about one day, the film is printed if desired. Whether or not printed, the film is converted into bags on a commercial bag machine. The bags may be monogrammed on the bag machine for identification. The bags are then chilled in a cooled warehouse in order to achieve final stabilization of the multilayer barrier shrink film bags.

### EXAMPLES 2-18

Multilayer barrier shrink film is prepared generally in accordance with the procedure described in Example 1, with variations in the resins passed into and through the coextruder. These different resins are listed as follows:

| | Heat Seal | Intermediate | | Innermost | | Intermediate | Abuse |
|---|---|---|---|---|---|---|---|
| Example | (Inside) | Core | Adhesive | Core | Adhesive | Core | (Outside) |
| 2 | ULDPE + | PVDC | Adhesive + | PER | Adhesive + | PVDC | ULDPE + |
| | EVA | | EVA | | EVA | | EVA |
| 3 | ULDPE + | PVDC | Adhesive + | PER + | Adhesive + | PVDC | EVA + |
| | EVA | | EVA | LLDPE | EVA | | Ionomer |
| 4 | ULDPE | PVDC | Adhesive | PER | Adhesive | PVDC | ULDPE |
| | | EVA | | | | EVA | |
| 5 | ULDPE + | PVDC | Adhesive | PER | Adhesive | PVDC | ULDPE + |
| | EVA | | | | | | EVA |
| 6 | ULDPE + | PVDC | Adhesive + | PER + | Adhesive + | PVDC | ULDPE + |
| | EVA | | EVA | ULDPE | EVA | | EVA |
| 7 | ULDPE + | PVDC | Adhesive | PER + | Adhesive | PVDC | ULDPE + |
| | Ionomer | | | polybutylene + | | | Ionomer |
| | | | | adhesive | | | |
| 8 | EVA + | PVDC | EVA | PER + EVA + | EVA | PVDC | EVA + |
| | Ionomer | | | adhesive | | | Ionomer |
| 9 | ULDPE + | PVDC | Adhesive + | PER + ULDPE | Adhesive + | PVDC | ULDPE + |
| | EVA | | EVA | | EVA | | EVA |
| 10 | ULDPE + | PVDC | EVA | PER + | EVA | PVDC | ULDPE + |
| | EVA | | | polybutylene + | | | EVA |
| | | | | adhesive | | | |
| 11 | ULDPE + | PVDC | Adhesive | PER + | Adhesive | PVDC | ULDPE + |
| | EVA | | | Ionomer | | | EVA |
| 12 | ULDPE + | PVDC | Adhesive + | PER + | Adhesive + | PVDC | ULDPE + |
| | EVA | | EVA | Ionomer | EVA | | EVA |
| 13 | ULDPE + | PVDC | Adhesive | PER + | Adhesive | PVDC | ULDPE + |
| | EVA | | | EVA | | | EVA |
| 14 | ULDPE + | PVDC | Adhesive + | PER | Adhesive + | PVDC | LLDPE + |
| | EVA | | EVA | | EVA | | Ionomer + |
| | | | | | | | EVA |
| 15 | ULDPE + | PVDC | Adhesive + | PER | Adhesive + | PVDC | ULDPE + |
| | EVA | | LLDPE | | LLDPE | | EVA |
| 16 | ULDPE + | PVDC | Adhesive + | PER | Adhesive + | PVDC | ULDPE + |
| | EVA | | ULDPE | | ULDPE | | Ionomer |
| 17 | ULDPE + | PVDC | Adhesive + | PER | Adhesive + | PVDC | ULDPE + |
| | EVA | | ULDPE | | ULDPE | | EVA + |
| | | | | | | | Ionomer |
| 18 | ULDPE + | PVDC | Adhesive + | PER + | Adhesive + | PVDC | ULDPE + |
| | EVA | | EVA | ethylene | EVA | | EVA |
| | | | | butene | | | |
| | | | | copolymer | | | |

It will be understood that the embodiments of the present invention which have been described are illustrative of some of the applications of the principles of the present invention. Numerous modifications may be made by those skilled in the art without departing from the true spirit and scope of the invention.

Although the present invention has been described with reference to preferred embodiments, workers skilled in the art will recognize that changes may be made in form and detail without departing from the spirit and scope of the invention.

1. The multilayered packaging film comprising:
a first exterior layer comprising of a heat sealable polymer on one side and a second exterior layer on an opposite side, and
two inner layers comprising polyvinylidene chloride between the first and second exterior layers and an innermost core layer disposed between the two polyvinylidene chloride layers wherein the innermost core layer is not cross-linkable when exposed to radiant energy.

2. The film of claim 1 wherein the innermost core layer is made of a polypropylene ethylene copolymer.

3. The film of claim 1 wherein the heat seal layer is made of an ultra low density polyethylene.

4. The film of claim 1 wherein the heat seal layer is made of an ethylene vinyl acetate polymer.

5. The film of claim 1 wherein the heat seal layer is a combination of very low density polyethylene and ethylene vinyl acetate.

6. The film of claim 1 wherein the second layer is made of a ultra low density polyethylene.

7. The film of claim 1 wherein the second exterior layer is made of an ethylene vinyl acetate polymer.

8. The film of claim 1 wherein the second exterior layer is made of a combination of an ultra low density polyethylene and an ethylene vinyl acetate polymer.

9. The film of claim 2 wherein the innermost core layer includes an ethylene acid co-polymer combined with a polypropylene co-polymer.

10. The film of claim 1 wherein the first exterior layer comprises approximately 40% of the thickness of the film, the second exterior layer comprises approximately 20% of the thickness of the film, the first and second inner polyvinylidene chloride layers each comprises approximately 6% of the thickness of the film and the innermost core layer comprises approximately 20% of the thickness of the film.

11. A package made of a multilayered film comprising:
a first exterior layer comprising of a heat sealable polymer on one side and a second exterior layer on an opposite side;
two inner layers comprising polyvinylidene chloride between the first and second exterior layers; and
an innermost core layer disposed between the two polyvinylidene chloride layers wherein the innermost core layer is not cross-linkable when exposed to radiant energy.

12. The film of claim 11 wherein the innermost core layer is made of a polypropylene ethylene copolymer.

13. The film of claim 11 wherein the heat seal layer is made of an ultra low density polyethylene.

14. The film of claim 11 wherein the heat seal layer is made of an ethylene vinyl acetate polymer.

15. The film of claim 11 wherein the heat seal layer is a combination of very low density polyethylene and ethylene vinyl acetate.

16. The film of claim 11 wherein the second layer is made of an ultra low density polyethylene.

17. The film of claim 11 wherein the second exterior layer is made of an ethylene vinyl acetate polymer.

18. The film of claim 11 wherein the second exterior layer is made of a combination of an ultra low density polyethylene and an ethylene vinyl acetate polymer.

19. The film of claim 12 wherein the innermost core layer includes an ethylene acid co-polymer combined with a polypropylene co-polymer.

20. The film of claim 11 wherein the first exterior layer comprises approximately 40% of the thickness of the film, the second exterior layer comprises approximately 20% of the thickness of the film, the first and second inner polyvinylidene chloride layers each comprises approximately 6% of the thickness of the film and the innermost core layer comprises approximately 20% of the thickness of the film.
